(19) United States
(12) Patent Application Publication
(10) Pub. No.: US 2006/0240175 A1
(43) Pub. Date: Oct. 26, 2006

(54) Composite candy and method for making the same

(75) Inventors: Gary D. Weiss, Redondo Beach, CA (US); Daniel G. Hart, Hermosa Beach, CA (US); Mark Weintraub, Leonia, NJ (US); Ron Werner, Wilkes-Barre, PA (US); Paul Angeloni, Waverly, PA (US); Fred Samala, Clarks Summit, PA (US)

Correspondence Address: DARBY & DARBY P.C., P. O. BOX 5257, NEW YORK, NY, 10150-5257, US

(73) Assignee: The Topps Company, Inc., New York, NY (US)

(21) Appl. No.: 11/389,438

(22) Filed: Mar. 23, 2006

Related U.S. Application Data
(60) Provisional application No. 60/664,655, filed on Mar. 23, 2005.

(51) Int. Cl. A23G 3/00

(52) U.S. Cl. 426/660

(57) ABSTRACT

A composite confectionary comprising a fat-based portion bonded to a cooked sugar-based portion. The portions are bonded by placing a contact surface of the cooked sugar-based portion in contact with a contact surface of the fat-based portion while the temperature of at least one of the fat-based portion contact surface and the cooked sugar-based portion contact surface is sufficient to at least partially melt the contact surface of the fat-based portion.

### FIELD OF INVENTION

The present invention relates to a composite confectionary food article, and a method for making the same. More particularly, it relates to a method for bonding a fat-based component to a cooked sugar-based component to form the composite confectionary food article.

### BACKGROUND OF THE INVENTION

Many confection articles are comprised of multiple food substances, to create complex and desirable tastes. Frequently, chocolates are mixed with, or surround, a filling composed of fruits, nuts, chocolates, or other confections. Hard candies that enclose a second confectionary are also commonly manufactured.

The combination of multiple confections is also used to enhance the esthetic and visual appeal of the confectionary article. One example is a truffle having an outer shell comprised of two halves, one made of milk chocolate, and another made of white chocolate. A further example includes a co-extruded confection in which the various confections extruded include different colors and patterns, thereby creating a pattern on the surface of or in the candy.

Creating confections that have multiple confectionary sections or components attached together requires determining the manner in which the components are to be attached. Several ways of attaching confections are known in the art.

Typically, the components attached together are similar in composition and, thus, have similar properties (e.g., white chocolate and dark chocolate, or two different hard candies). The similarity in properties allows for relatively easy bonding of the two components. For example, chocolate can be bonded together by pouring multiple layers of chocolate into a mold, as disclosed in U.S. Pat. No. 3,545,981, issued Dec. 8, 1970, to Klein et al. A further example is disclosed in U.S. Pat. No. 6,660,318, issued Dec. 9, 2003, to Yoon et al., which describes a method of manufacturing a multi-component hard candy by using a joint pin to press together two hard candy molds.

Some confectionary substances can not be bonded together through manufacturing process. U.S. Pat. No. 1,382,601, issued Jun. 21, 1921, to Cressey, addresses this problem by using an edible sealing mixture comprising flour, gelatin, and water to join two sections of crisply baked dough.

Dissimilar confectionary substances that do not have similar properties are more difficult to bond together. One solution is to structurally retain one section within another. U.S. Pat. No. 6,759,079, issued Jul. 6, 2004, to Klug et al., discloses a multi-sided base unit having a hollow center and a plurality of angled side walls to retain a second confectionary component. A process for bonding together two or more dissimilar confectionary substances is needed in the art.

### SUMMARY OF THE INVENTION

The present invention relates to a confectionary food article, and a method for making the confectionary food article, having a fat-based component bonded to a cooked sugar-based component.

One aspect of this invention provides a method for making a composite confectionary having a fat-based portion bonded to a cooked sugar-based portion. The method provides that a fat-based portion is deposited into a first mold. A contact surface of a cooked sugar-based portion is placed in substantially flush contact with a contact surface of the fat-based portion while the temperature of at least one of the fat-based portion contact surface and the cooked sugar-based portion contact surface is sufficient to at least partially melt the contact surface of the fat-based portion. The composite confectionary is then cooled to allow the fat-based portion and the cooked sugar-based portion to bond together, thereby forming the composite confectionary.

In a further aspect, the method can include forming the cooked sugar-based portion by depositing it, in a molten state, into a second mold. The cooked sugar-based portion is then cooled to a temperature suitable for de-molding. The cooked sugar-based portion can then be placed in substantially flush contact with a contact surface of the fat-based portion while the temperature of at least one of the fat-based portion contact surface and the cooked sugar-based portion contact surface is sufficient to at least partially melt the contact surface of the fat-based portion, as noted above. The composite confectionary can then be cooled to allow the fat-based portion and the cooked sugar-based portion to bond together, thereby forming the composite confectionary, as noted above.

Another aspect according to the invention provides a composite confectionary comprising a fat-based portion, having a contact surface that is bonded to a cooked sugar-based portion having a contact surface. The bond between the cooked sugar-based portion and the fat-based portion is formed by placing the contact surface of the cooked sugar-based portion in substantially flush contact with the contact surface of the fat-based portion while the temperature of at least one of the fat-based portion contact surface and the cooked sugar-based portion contact surface is sufficient to at least partially melt the contact surface of the fat-based portion.

According to a further aspect of the invention, the composite confectionary comprises a fat-based portion having a contact surface, a cooked sugar-based portion having a contact surface, and an interface, preferably substantially free of intervening substances, comprising a direct engagement of the contact surface of the fat-based portion and the contact surface of the cooked sugar-based portion. The interface has a non-melted state in the composite confectionary and a partially melted state at a time prior to engagement with the contact surface of the sugar-based portion.

### BRIEF DESCRIPTION OF THE DRAWINGS

The foregoing and other features of the present invention will be more readily apparent from the following detailed description and drawings of illustrative embodiments of the invention in which:

FIG. 1 is a top front perspective view of a first embodiment of the invention;

FIG. 2 is an exploded top front perspective view of the first embodiment of the invention;

FIG. 3 is a front elevation view of the first embodiment of the invention;

FIG. 4 is a left side elevation view of the first embodiment of the invention;

FIG. 5 is a bottom plan view of the first embodiment of the invention; and

FIG. 6 is a top plan view of the first embodiment of the invention.

### DETAILED DESCRIPTION OF THE PREFERRED EMBODIMENTS

Referring now to the drawings, the present invention is directed to a compound confectionary 10 having a fat-based portion 30 and a cooked sugar-based portion 20 bonded together along the contact surface 50 of the fat-based portion 30 and the contact surface 60 of the cooked sugar-based portion 20.

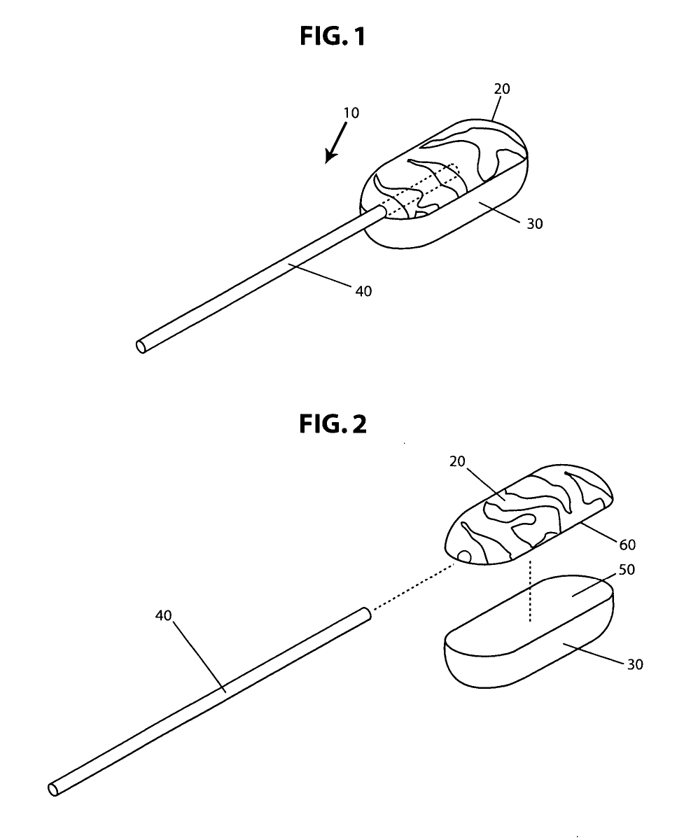

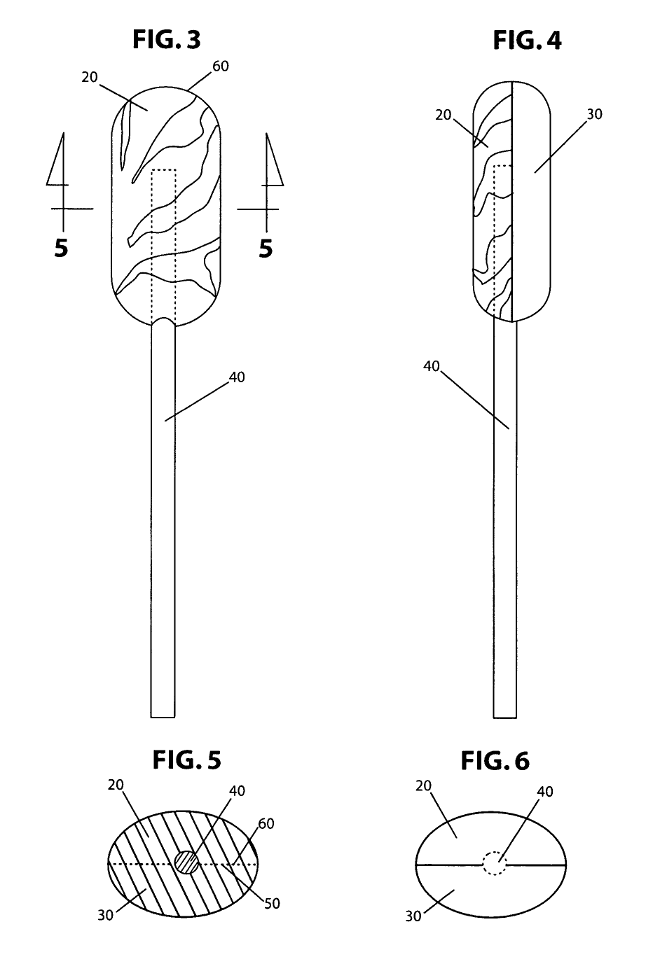

FIGS. 1-6 illustrate one embodiment of the composite confectionary 10 in the shape of an elongated cylinder having rounded ends, which is split approximately in half along the longitudinal axis. The fat-based portion 30 and the cooked sugar-based portion 20 each form approximately half of the composite confectionary 10. The invention is not limited to the shape illustrated. It should be noted that the composite confectionary 10 can take any shape which can be divided to provide contact surfaces 60 and 50 having sufficient area to bond the two portions. Examples of acceptable shapes include spheres, cubes, rectangular solids, and more complex designs such as seasonal shapes (e.g., pumpkins, hearts, and flags). It should further be noted that, while the ratio of fat-based portion 30 to the cooked sugar-based portion 20 illustrated is approximately 1:1, the ratio of the fat-based portion 30 to the cooked sugar-based portion 20 can be varied substantially.

The fat-based portion 30 includes confectionaries that are considered in the art to be fat-based and can include varieties of chocolate and compound coating. The fat-based portion 30 can also include various flavoring, coloring, and other additives that do not substantially affect the melting point of the substance or its fat-based composition. The fat-based portion 30 can also include sugarless equivalents of fat-based confections.

The cooked sugar-based portion 20 includes confectioneries that are considered in the art as cooked sugar-based. Additionally, the cooked sugar-based portion 20 should be considered to include sugarless equivalents of the cooked sugar-based confections known in the art. Preferably, the cooked sugar-based portion 20 includes a hard candy formulation such as those known in the art. However, the cooked sugar-based portion 20 is not limited to hard candy, and the process of bonding a fat-based confection to a cooked sugar-based confection, described herein, can be used with a wide variety of non-hard candy confections including marshmallows, caramel, gelatin-based confections, taffy-like confections, chewy candy, and other similar confections. Certain sugar-based confections, for example caramel or specific lollipop compositions, may contain a certain amount of fat. However, it is understood in the art that such confections are not considered fat-based, but rather cooked sugar-based.

Both the cooked sugar-based portion 20 and the fat-based portion 30 can be provided with variations in ornamentation and design. The ornamentation and design can include the shape, as discussed above with respect to the cooked sugar-based portion 20, coloring, texture, and additional surface attachments such as sprinkles or edible glitter. For example, cooked sugar-based-portion 20 is illustrated in the FIGS. 1-4 as including multiple swirls of color visible on its surfaces.

In one embodiment of the present invention, the composite confectionary 10 is made by depositing the cooked sugar-based portion 20 in a molten state into a mold, and cooled to a temperature suitable for demolding. A fat-based portion 30 is also deposited, in a molten state, into a mold. Before a contact surface 50 of the fat-based portion 30 hardens, a contact surface 60 of the cooked sugar-based portion 20 is placed in substantially flush contact with a contact surface 50 of the fat-based portion 30, thus forming the composite confectionary 10. The confectionary is then cooled to allow the fat-based portion 30 and the cooked sugar-based portion 20 to bond together.

The combination of the fat-based portion 30 and the cooked sugar-based portion 20 can be performed in a variety of ways that allow the contact surfaces 50 and 60 of each portion to bond together. In one aspect of the invention, the temperature of at least one of the contact surface 50 of the fat-based portion 30 and the contact surface 60 of the cooked sugar-based portion 20 is preferably sufficient to at least partially melt the contact surface 50 of the fat-based portion 30.

In another embodiment of the invention, either, or both, the fat-based portion 30 and the cooked sugar-based portion 20 can be pre-formed and in a solid state. At least one of the contact surfaces 50 and 60 of fat-based portion 30 and the cooked sugar-based portion 20 is then heated to a temperature sufficient to at least partially melt the contact surface 50 of the fat-based portion 30. The contact surfaces 50 and 60 are then placed together in a substantially flush contact to form the composite confectionary 10. The fat-based portion 30 and the cooked sugar-based portion 20 will then bond as the composite confection 10 cools.

In a more particular aspect of one embodiment of this invention the molten cooked sugar-based portion 20 is deposited into a metal mold and cooled for approximately 10 minutes at 68° F. and 50% Relative Humidity (RH) until it reaches a temperature between about 70° F. and 75° F. However, it is known in the art that the cooked sugar-based portion 20 can be cooled to a temperature between about 0° F. and 130° F. that will allow it to be readily de-molded. If the contact surface 60 of the cooked sugar-base portion 20 is at a temperature substantially higher than 130° F. when it is placed in contact with the fat-based-portion 30, scorching of the fat-based portion 30 can result. Therefore, the temperature of the fat-based portion 30 should not be allowed to go above about 130° F

In yet another aspect of one embodiment of this invention, the fat-based portion 30 is preferably deposited in a plastic mold at about 85° F. to about 130° F. In one preferred embodiment the fat-based portion 30 is deposited at about 105° F. After depositing the fat-based portion 30, the cooled cooked sugar-based portion 20 is placed in contact with the fat-based portion 30 before the fat-based portion 30 has cooled substantially from the depositing temperature. The depositing temperature can vary depending on the specific composition of the fat-based portion 30 in order to prevent scorching and to ensure the contact surface 50 is sufficiently melted when it is placed in contact with contact surface 60 of the cooked sugar-based portion.

Once the composite confectionary 10 is formed, it is placed into a cool condition so it can be de-molded. Standard confectionary cooling conditions may be used. In a more particular aspect of one embodiment, the composite confectionary 10 is cooled at about 40° F. and 60% RH before de-molding.

In a further aspect of the invention, the confection can include a stick 40, or similar device, to form a lollipop type structure. The stick 40 can be inserted entirely in either the fat-based portion 30 or the cooked sugar-based portion 20 during the formation of the respective portions. Alternatively, the stick 40 can be placed between the fat-based portion 30 and the cooked sugar-based portion 20. In addition to providing a convenient handle type structure, this configuration provides a secondary surface to which the fat-based portion 30 and the cooked sugar-based portion 20 can bond together.

In yet another embodiment of this invention, the contact surface 60 of the cooked sugar-based portion 20 can be provided with a rough or varied surface. The rough or varied surface can be used to enhance the bonding between the fat-based portion 30 and the cooked sugar-based portion 20. The rough surface increases the surface area of the contact surfaces 50 and 60. Additionally, a rough surface can be used to create a sufficient bond between the fat-based portion 20 and the cooked sugar-based portion 30 when molded or combined outside the preferred temperature ranges discussed herein.

In a further aspect of one embodiment of this invention, the bond between the fat-based portion 30 and the cooked sugar-based portion 20 can further be enhanced by at least one pre-formed candy nub or depression (not shown) in the cooked sugar-based portion 20 so that when the fat-based portion 30 and the cooked sugar-based portion 20 are placed together, the nubs are partially inserted into each portion thereby increasing contact surface area and enhancing the bond. The nubs can be formed in a variety of ways. For example, preformed candy pieces can form a nub by inserting it into the contact surface 60 of the cooked sugar-based portion 20. Alternatively, the cooked sugar-based portion 20 can be formed such that the nubs are integrated into the shape of the cooked sugar-based portion 20, for example by use of a book mold. This aspect of the invention can also be used to create a sufficient bond outside of the preferred temperature range for the fat-based portion 30 and the cooked sugar-based portion 20.

In a further aspect of this invention, whether utilizing pre-formed confectionary portions, or performing the process of molding the confectionary components, the contact surface 60 of the cooked sugar-based portion 20 can be heated to a temperature between about 125° F. and 175° F. prior to placing the cooked sugar-based portion 20 in contact with the contact surface 50 of the fat-based portion 30. To prevent scorching, the temperature of the fat-based portion 30 should not go over 130° F. Alternatively, the fat-based portion 30 can be heated to a temperature at which the contact surface of the fat-based 30 begins to melt. Either of these embodiments can be employed when the fat-based portion 30 and the cooked sugar-based portion 20 are substantially solidified.

While the invention has been shown by way of reference to a compound composite confectionary have a fat-based confectionary portion and a cooked sugar-based confectionary portion, it will be understood by those skilled in the art that the present invention may be utilized in any compound composite confectionary and that various changes in form and details may be made therein without departing from the spirit and scope of the invention.

We claim:

1. A method of making a composite confectionary comprising:
depositing a fat-based portion into a first mold;
placing a contact surface of a cooked sugar-based portion in substantially flush contact with a contact surface of the fat-based portion while the temperature of at least one of the fat-based portion contact surface and the cooked sugar-based portion contact surface is sufficient to at least partially melt the contact surface of the fat-based portion; and
cooling the composite confectionary to allow the fat-based portion and the cooked sugar-based portion to bond., thereby forming the composite confectionary.

2. The method of making a composite confectionary of claim 1, wherein:
the fat-based portion is deposited in a molten state.

3. The method of making a composite confectionary of claim 1 further comprising the steps of:
depositing the cooked sugar-based portion in a molten state into a second mold; and
cooling the first cooked sugar-based portion to a temperature suitable for de-molding;

4. The method of making a composite confectionary of claim 1, wherein:
the cooked sugar-based portion includes a hard candy.

5. The method of making a composite confectionary of claim 3, further comprising the step of:
forming candy nubs in the contact surface of the cooked sugar-based portion.

6. The method of making a composite confectionary of claim 4, wherein:
the cooked sugar-based portion is cooled to a temperature between about 0° F. and 130° F.

7. The method of making a composite confectionary of claim 1, wherein:
the fat-based portion includes at least one of compound coating or chocolate.

8. The method of making a composite confectionary of claim 1, further comprising the steps of:
providing the contact surface of the cooked sugar-based portion with an uneven surface.

9. The method of making a composite confectionary of claim 1, further comprising the step of:
placing a stick in one of the cooked sugar-based portion and the fat-based portion.

10. The method of making a composite confectionary of claim 1, further comprising the step of:
placing a stick in between the fat-based portion and the cooked sugar-based portion so that the stick is in contact with at least a portion of the contact surface of the fat-based portion and at least a portion of the contact surface of the cooked sugar-based portion.

11. The method of making a composite confectionary of claim 1, further comprising the step of:
heating the contact surface of the cooked sugar-based portion to a temperature between about 125° F. and about 175° F., prior to placing the cooked sugar-based portion in contact with the fat-based portion.

12. The method of making a composite confectionary of claim 1, further comprising the step of:
heating the contact surface of the fat-based portion to a temperature at which the fat-based portion begins to melt, prior to placing the cooked sugar-based portion in contact with the fat-based portion.

13. The method of making a composite confectionary of claim 2, wherein:
the fat-based portion is deposited into the first mold at about 85° F. to about 130° F.

14. The method of making a composite confection of claim 1, wherein:
the cooked sugar-based portion includes a non-hard candy confection.

15. The method of making a composite confection of claim 1, wherein:
the fat-based portion includes a sugarless confectionary.

16. The method of making a composite confection of claim 1, wherein:
the cooked sugar-based portion includes a sugarless confectionary.

17. A composite confectionary comprising:
a fat-based portion having a contact surface; and
a cooked sugar-based portion having a contact surface, the cooked sugar-based portion being bonded to fat-based portion;
wherein the bond between the cooked sugar-based portion and the fat-based portion is formed by placing the contact surface of the cooked sugar-based portion in substantially flush contact with the contact surface of the fat-based portion while the temperature of at least one of the fat-based portion contact surface and the cooked sugar-based portion contact surface is sufficient to at least partially melt the contact surface of the fat-based portion.

18. The composite confectionary of claim 17, further comprising:
at least one candy nub, each candy being disposed between the at least a portion of the contact surface of the cooked sugar-based portion and at least a portion of the contact surface of the fat-based portion.

19. The composite confectionary of claim 17, wherein:
the cooked sugar-based portion includes a hard candy.

20. The composite confectionary of claim 17, wherein:
the fat-based portion includes at least one of compound coating or chocolate.

21. The composite confectionary of claim 17, wherein:
the contact surface of the cooked sugar-based portion includes an uneven surface.

22. The composite confectionary of claim 17, further comprising:
a stick disposed partially within in one of the cooked sugar-based portion and the fat-based portion.

23. The composite confectionary of claim 17, further comprising:
a stick partially disposed between at least a portion of the contact surface of the fat-based portion and a portion of the contact surface of the cooked sugar-based portion

24. The composite confectionary of claim 17, wherein:
the cooked sugar-based portion includes a non-hard candy confection.

25. A composite confectionary comprising:
a fat-based portion having a contact surface;
a cooked sugar-based portion having a contact surface; and
an interface, substantially free of intervening substances, comprising a direct engagement of the contact surface of the fat-based portion and the contact surface of the cooked sugar-based portion, the interface having a non-melted state in the composite confectionary and a partially melted state at a time prior to engagement with the contact surface of the sugar-based portion.
